(19) United States
(12) Patent Application Publication
(10) Pub. No.: US 2011/0223478 A1
(43) Pub. Date: Sep. 15, 2011

(54) SECONDARY BATTERY AND SECONDARY BATTERY MODULE USING THE SAME

(75) Inventor: You Hie HAN, Daejon (KR)

(73) Assignee: IPG PHOTONICS (KOREA) Ltd., Daejon (KR)

(21) Appl. No.: 12/882,997

(22) Filed: Sep. 15, 2010

(30) Foreign Application Priority Data
Mar. 12, 2010 (KR) 10-2010-0022248
Jun. 16, 2010 (KR) 10-2010-0056881

(51) Int. Cl. H01M 10/02; H01M 10/38

(52) U.S. Cl. 429/211; 429/158; 429/162

(57) ABSTRACT

A secondary battery includes a cell body having an electrode assembly disposed therein; and an electrode tab extending from each electrode of the electrode assembly to an outside of the cell body in a specified direction, and having at least one flexed part at an intermediate portion thereof.

### CROSS-REFERENCES TO RELATED APPLICATION

The present application claims priority under 35 U.S.C. §119(a) to Korean application number 10-2010-0022248, filed on Mar. 12, 2010, and Korean application number 10-2010-0056881, filed on Jun. 16, 2010 in the Korean Intellectual Property Office, which is incorporated herein by reference in its entirety as set forth in full.

### BACKGROUND

1. Technical Field

The present invention relates to a battery, and more particularly, to a secondary battery and a secondary battery module using the same.

2. Related Art

As restriction for the use of materials which can cause environmental pollution such as a greenhouse effect of the earth is tightened, products helpful to the protection of environments are gaining popularity, and this atmosphere has exerted influences on the automobile industry.

In step with such a situation, electric cars which use electric batteries and electric motors have been commercialized in some nations. Since electric cars use batteries as power sources, batteries which are cheap and capable of maximizing energy storage capacity and an available service period are needed. These days, various kinds of secondary batteries are used as batteries for electric cars.

A unit cell of a secondary battery includes an anode plate as an anode collector coated with a positive active material, a cathode plate as a cathode collector coated with a negative active material, and a separator inserted between the anode plate and the cathode plate. An electrode assembly which is composed of the anode plate, the cathode plate and the separator is received in a pouch and is then sealed.

Because a large-sized electric vehicle such as an electric scooter or an electric car needs a battery with a high output and large capacity, a plurality of secondary battery unit cells are used by being electrically connected. That is to say, in an example, a secondary battery module is constructed by arranging a plurality of secondary battery unit cells in a hexahedral case and electrically connecting in series or in parallel electrode tabs which extend from the anode plates and the cathode plates of the respective unit cells.

FIGS. 1a and 1b are views illustrating the constructions of secondary battery unit cells.

First, FIG. 1a shows a unit cell 10 in which two electrode plates are oppositely installed. An electrode assembly 12 is installed in a case 14. The electrode assembly 12 includes a first electrode tab 16 from which a first pole plate of the electrode assembly 12 extends, and a second electrode tab 18 which is installed in a direction opposite to the first electrode tab 16 and from which a second pole plate of the electrode assembly 12 extends.

The first electrode tab 16 and the second electrode tab 18 can be formed by extending electrodes themselves or by connecting conductive plates to the electrodes.

FIG. 1b shows a unit cell 20 in which two electrode plates are disposed parallel to each other.

Similarly to the case of FIG. 1, an electrode assembly 22 is installed in a case 24. The electrode assembly 22 includes a first electrode tab 26 from which a first pole plate extends, and a second electrode tab 28 which is installed in a direction parallel to the first electrode tab 26 while being separated from the first electrode tab 26 by a predetermined distance.

In the case where these secondary battery unit cells are applied to appliances such as automobiles which need batteries with high capacity, a plurality of unit cells should be connected in series or in parallel. Recently, laser beams are employed for electrical connection of electrode tabs, which will be described below with reference to FIGS. 2 through 4.

FIGS. 2 through 4 are views illustrating conventional ways of connecting electrodes of secondary battery unit cells.

First, FIG. 2 shows a case in which electrodes of unit cells are connected using a separate conductive member.

When a first unit cell 32 and a second unit cell 34 are brought into contact with each other, an electrode 320 of the first unit cell 32 and an electrode 340 of the second unit cell 34 cannot help but be separated from each other due to a difference between the thickness of the unit cells 32 and 34 and the thickness of the electrodes 320 and 340.

Thus, a conductive member 36 such as a bus bar is installed between the two electrodes 320 and 340. Laser beams are radiated to a contact site A of the electrode 320 and the conductive member 36 and a contact site B of the electrode 340 and the conductive member 36, by which the two unit cells 32 and 34 are electrically contacted with each other.

In this case, since the separate member should be used to connect the unit cells, inefficiency is caused in that additional processes and costs are incurred.

FIG. 3 shows a case in which electrodes of unit cells are formed by being bent and are then connected with each other.

That is to say, an electrode 420 of a first unit cell 42 is formed by being bent in one direction, and an electrode 440 of a second unit cell 44 is formed by being bent in such a way as to overlap with the electrode 420 of the first unit cell 42.

In this state, by bringing the first unit cell 42 and the second unit cell 44 into contact with each other, the electrodes 420 and 440 overlap with each other by a predetermined area. Accordingly, by radiating a laser beam to a contact site C of the two electrodes 420 and 440, the two unit cells 42 and 44 are electrically connected with each other.

When subjects are brought into contact with each other by a laser beam, a contact area is created by a spot size of the laser beam. Two conductive materials have low resistance as the contact area therebetween increases, and therefore, in order to reduce driving current, it is necessary to increase the contact area.

However, when the two electrodes 420 and 440 are brought into contact with each other as shown in FIG. 3, only a contact area corresponding to the spot size of the laser beam is secured. As a consequence, because limitations exist in increasing the spot size due to the thickness of the electrodes 420 and 440, it is difficult to minimize contact resistance.

FIG. 4 shows a case in which electrodes of two unit cells are squeezed and brought into close contact with each other and a laser beam is radiated to connect the two unit cells.

With a first unit cell 52 and a second unit cell 54 arranged, two electrodes 520 and 540 are squeezed toward each other. When the two electrodes 520 and 540 are brought into close contact with each other, a laser beam is radiated to a contact site D.

The laser beam is radiated not in a horizontal or vertical direction but to have a slope less than 90°.

The reason why the laser beam cannot be radiated in a horizontal direction is because the laser beam cannot be radiated to a precise position due to the presence of adjacent unit cells with a plurality of unit cells arranged.

Further, the reason why the laser beam cannot be radiated in a vertical direction is because the laser beam can pass between the two electrodes 520 and 540 when the two electrodes 520 and 540 are not brought into close contact with each other. If the laser beam passes between the two electrodes 520 and 540, the laser beam can be radiated to an electrode assembly of a unit cell, and due to this fact, the unit cell is likely to be broken or a fire is likely to occur.

Hence, as the laser beam is radiated to have a slope less than 90°, problems are caused in that the possibility of a laser beam radiation position to change increases and work efficiency can deteriorate.

In the case of connecting unit cells as shown in FIG. 4, since a contact area between two electrodes is proportional to a spot size of the laser beam, limitations exist in securing a wide contact area.

### SUMMARY

In one embodiment of the present invention, a secondary battery includes: a cell body having an electrode assembly disposed therein; and an electrode tab extending from each electrode of the electrode assembly to an outside of the cell body in a specified direction, and having at least one flexed part at an intermediate portion thereof.

In another embodiment of the present invention, there is provided a secondary battery module using a secondary battery unit cell including a cell body which has an electrode assembly disposed therein and an electrode tab which extends from each electrode of the electrode assembly to an outside of the cell body, wherein the electrode tab extends in a specified direction from the cell body and has at least one flexed part at an intermediate portion thereof, and electrode tabs of at least one pair of adjacent secondary battery unit cells electrically contact each other.

### BRIEF DESCRIPTION OF THE DRAWINGS

Features, aspects, and embodiments are described in conjunction with the attached drawings, in which:

FIGS. 1a and 1b are views illustrating the constructions of secondary battery unit cells;

FIGS. 2 through 4 are views illustrating conventional ways of connecting electrodes of secondary battery unit cells;

FIG. 5 is a view illustrating the construction of a secondary battery unit cell in accordance with a first embodiment of the present invention;

FIGS. 6 and 7 are views illustrating a way of connecting electrodes of secondary battery unit cells as shown in FIG. 5;

FIG. 8 is a view explaining an effect of preventing erroneous radiation of a laser beam when connecting electrodes of secondary battery unit cells according to the present invention;

FIG. 9 is a view illustrating the construction of a secondary battery unit cell in accordance with a second embodiment of the present invention;

FIGS. 10 and 11 are views illustrating the construction of a secondary battery unit cell in accordance with a third embodiment of the present invention;

FIG. 12 is a view illustrating the construction of a secondary battery unit cell in accordance with a fourth embodiment of the present invention; and

FIG. 13 is a view illustrating the construction of a secondary battery unit cell in accordance with a fifth embodiment of the present invention.

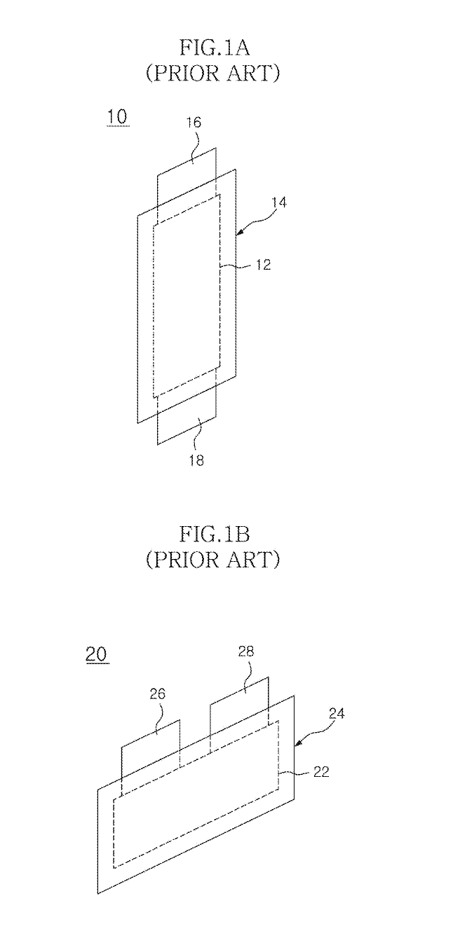

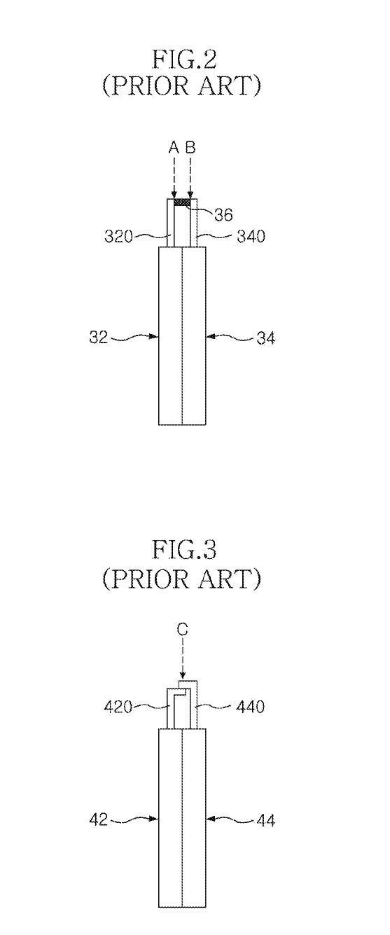

### DETAILED DESCRIPTION

Hereinafter, a secondary battery and a secondary battery module using the same according to the present invention will be described below with reference to the accompanying drawings through exemplary embodiments.

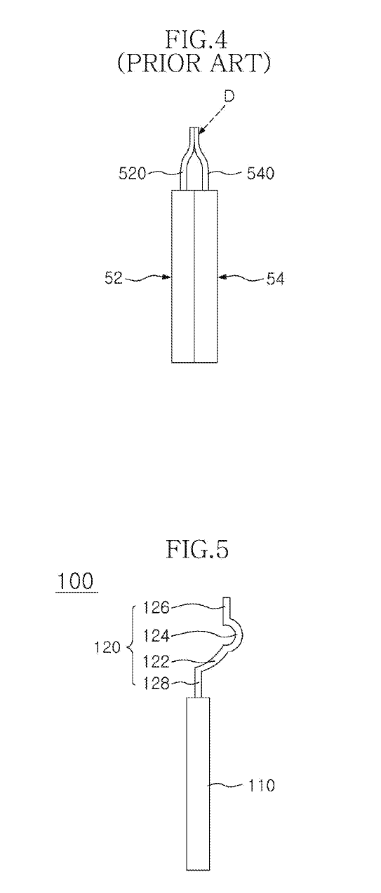

FIG. 5 is a view illustrating the construction of a secondary battery unit cell in accordance with a first embodiment of the present invention.

Referring to FIG. 5, a secondary battery unit cell 100 in accordance with a first embodiment of the present invention includes a cell body 110 in which an electrode assembly is disposed, and an electrode tab 120 which extends from each electrode of the electrode assembly to the outside of the cell body 110.

While only one electrode tab 120 is illustrated in FIG. 5, it is to be noted that the secondary battery unit cell 100 has a positive electrode tab and a negative electrode tab. The electrode tab 120 can be formed by extending an electrode disposed in the cell body 110 to the outside or by connecting a conductive plate to the electrode disposed in the cell body 110.

The electrode tab 120, which is provided in the secondary battery unit cell 100 in accordance with the first embodiment of the present invention, includes a first plate part 122, at least one flexed part 124, and a second plate part 126. The electrode tab 120 can further include a lead part 128 for securing a minimum connection distance with respect to an electrode tab of an adjacent unit cell. In detail, the first plate part 122 has a sectional shape of a straight line or a curved line when viewed from a side, and extends in a first direction from the cell body 110. The flexed part 124 extends in the first direction from the first plate part 122 in such a way as to have a flexed portion when viewed from a side. The second plate part 126 has a sectional shape of a straight line or a curved line when viewed from a side, and extends in the first direction from the flexed part 124.

The cell body 110 can be formed to have flat front and rear surfaces, and the electrode tab 120 can be formed on the same plane as one of the flat front and rear surfaces of the cell body 110. In this case, the first plate part 122 can be formed to have a flat surface or a flexed surface which extends from the flat surface of the cell body 110. The flexed part 124 can be formed to have a flexed surface which extends from the flat or flexed surface of the first plate part 122. The second plate part 126 can be formed to extend from the flexed surface of the flexed part 124 and to have a flat surface which extends in the lengthwise direction of the cell body 110.

In the case where the electrode tab 120 is constructed in this way, when electrodes of two adjacent unit cells are brought into contact with each other, a laser beam can be vertically radiated from the distal ends of electrode tabs 120. In other words, because flexed parts which are formed in two adjacent electrode tabs are engaged with each other, even when a laser beam is radiated in a state in which the two electrode tabs are not brought into close contact with each other, it is possible to prevent cell bodies 110 positioned downward from being adversely influenced.

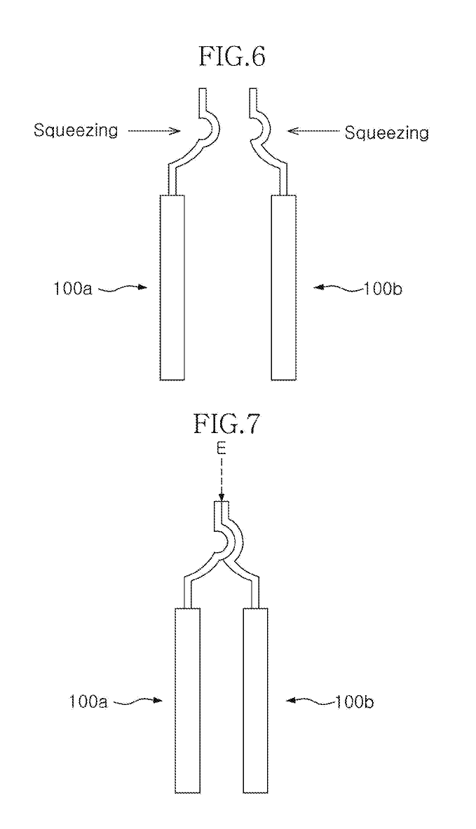

FIGS. 6 and 7 are views illustrating a way of connecting electrodes of secondary battery unit cells as shown in FIG. 5.

First, as shown in FIG. 6, a pair of secondary battery unit cells 100a and 100b are arranged close to each other. Then, electrode tabs of the respective unit cells 100a and 100b are squeezed toward each other by a squeezing device (not shown).

Thereupon, as shown in FIG. 7, the two electrode tabs are brought into close contact with each other. In this state, by radiating a laser beam to a contact site E, the two electrode tabs are electrically connected with each other. Namely, the laser beam is radiated vertically downward in the first direction along which the second plate parts 126 extend.

As a result, second plate parts which are formed in the two electrode tabs are electrically connected with each other by the radiation of the laser beam. When assuming the case of welding two conductors, a contact area increases in proportion to a welding depth. In the embodiment of the present invention, a welding depth can be secured by the length of the second plate parts. Accordingly, contact resistance can be reduced in correspondence to a contact area between the second plate parts, whereby the electrical characteristics of a secondary battery module can be improved.

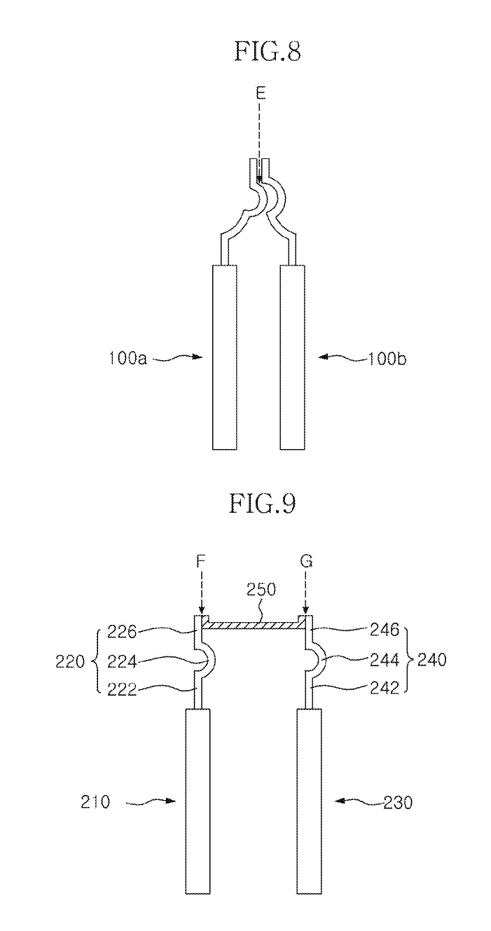

FIG. 8 is a view explaining an effect of preventing erroneous radiation of a laser beam when connecting electrodes of secondary battery unit cells according to the present invention.

In the course of electrically contacting a pair of secondary battery unit cells, the laser beam can be radiated in a state in which the electrode tabs are in a poor contact state.

Since the laser beam radiation position E is determined in advance as a manufacturing parameter, in the case where the two electrode tabs are not brought into close contact with each other, the laser beam may not properly weld the second plate parts.

In this regard, in the electrode tab contact structure shown in FIG. 4, the laser beam may be radiated to the cell body so that a unit cell is broken or a fire occurs. However, the secondary battery unit cell according to the present invention has the electrode tabs each of which has at least one flexed part. Accordingly, even when the laser beam is radiated in a state in which the upper ends of the electrode tabs, that is, the second plate parts are not brought into close contact with each other, the laser beam is radiated not to the cell bodies of the secondary battery unit cells 100a and 100b but to the flexed parts.

As a consequence, it is possible to prevent the breakage of a unit cell and the occurrence of a fire resulting from improper radiation of a laser beam.

FIG. 9 is a view illustrating the construction of a secondary battery unit cell in accordance with a second embodiment of the present invention.

A secondary battery unit cell in accordance with a second embodiment of the present invention has a structure in which the lead part 128 shown in FIG. 5 is removed from the unit cell. The lead part 128 is a component element which functions to secure a minimum connection distance with respect to an adjacent cell electrode. In FIG. 9, the lead part 128 is omitted, and two electrodes are connected using a separator 250.

That is to say, respective unit cells include cell bodies 210 and 230 in which electrode assemblies are disposed, and electrode tabs 220 and 240 which extend from respective electrodes of the electrode assemblies to the outsides of the cell bodies 210 and 230. The respective electrode tabs 220 and 240 include first plate parts 222 and 242 which have a sectional shape of a straight line when viewed from a side and extend in a first direction from the cell bodies 210 and 230, flexed parts 224 and 244 which extend in the first direction from the first plate parts 222 and 242 in such a way as to have flexed portions when viewed from a side, and second plate parts 226 and 246 which have a sectional shape of a straight line when viewed from a side and extend in the first direction from the flexed parts 224 and 244. The adjacent unit cells are connected by the separator 250 which is spanned between the second plate parts 226 and 246.

In order to form a secondary battery module, laser beams are radiated to contact sites F and G between the second plate parts 226 and 246 and both ends of the separator 250.

In this case, while a situation, in which the second plate parts 226 and 246 and the separator 250 are not brought into close contact with each other, may occur, the flexed parts 224 and 244 can prevent the laser beams from being erroneously radiated to the cell bodies 210 and 230.

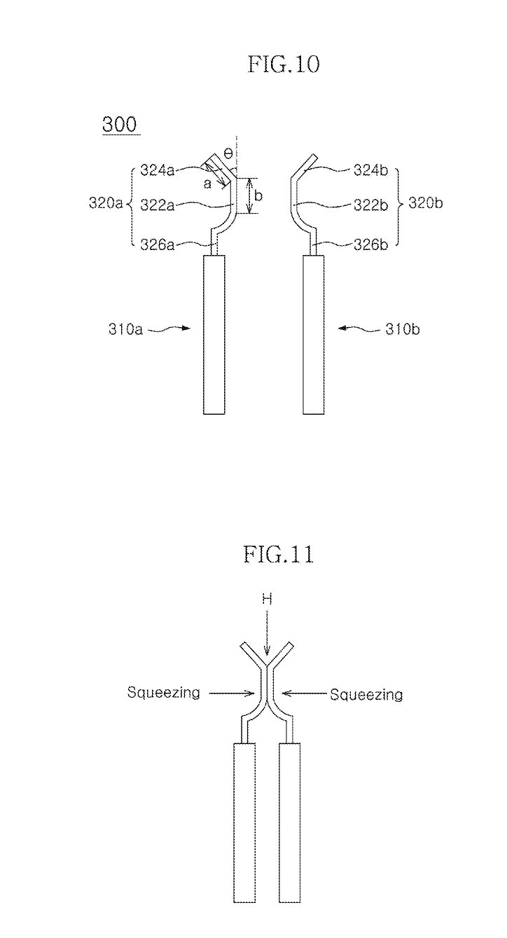

FIGS. 10 and 11 are views illustrating the construction of a secondary battery unit cell in accordance with a third embodiment of the present invention.

Secondary battery unit cells 300 shown in FIG. 10 include cell bodies 310a and 310b in which electrode assemblies are disposed, and electrode tabs 320a and 320b which extend from respective electrodes of the electrode assemblies to the outsides of the cell bodies 310a and 310b. The electrode tabs 320a and 320b can be formed by extending the electrodes disposed in the cell bodies 310a and 310b to the outsides or by connecting conductive plates to the electrodes disposed in the cell bodies 310a and 310b.

The electrode tabs 320a and 320b, which are provided in the secondary battery unit cells 300 according to the embodiment of the present invention, include plate parts 322a and 322b, and reflective parts 324a and 324b which extend from the plate parts 322a and 322b and are bent outward from a contact site of the two electrode tabs 320a and 320b by a predetermined angle θ. The electrode tabs 320a and 320b can further include lead parts 326a and 326b for securing a minimum connection distance with respect to the electrodes of adjacent unit cells.

In detail, the plate parts 322a and 322b have flat portions b which extend from the cell bodies 310a and 310b in a first direction. The reflective parts 324a and 324b are bent from the plate parts 322a and 322b by the predetermined angle θ and extend by a predetermined length a. The reflective parts 324a and 324b can be bent in opposite directions from the contact site so as to ensure the contact of the electrodes of the adjacent unit cells.

In the embodiment of the present invention, the length a of the reflective parts 324a and 324b can be set to 0.2 to 5 mm, and the length of the flat portions b included in the plate parts 322a and 322b can be set to 1 to 10 mm. The bent angle θ of the reflective parts 324a and 324b can be set to 2° to 45°.

The cell bodies 310a and 310b can be formed to have flat front and rear surfaces, and the electrode tabs 320a and 320b can be formed on the same plane as one of the flat front and rear surfaces of the cell bodies 310a and 310b. As described above, the plate parts 322a and 322b can be formed to have the flat portions b which extend from the flat surfaces of the cell bodies 310a and 310b.

FIG. 11 is a view explaining a way of contacting the unit cells shown in FIG. 10.

After adjacently arranging the pair of secondary battery unit cells 300, the electrode tabs 320a and 320b of the respective unit cells 300 are squeezed toward each other by a squeezing device (not shown) and are thereby brought into contact with each other.

Due to this fact, the two electrode tabs 320a and 320b come into close contact with each other. In this state, by radiating a laser beam to a contact site H, the two electrode tabs 320a and 320b are electrically connected with each other. Since the electrode tabs 320a and 320b according to the embodiment of the present invention have the reflective parts 324a and 324b, multiple reflection occurs on the surfaces of the reflective parts 324a and 324b when radiating the laser beam, and therefore, the laser beam can be focused centrally, that is, on the contact site H. Hence, even when the laser beam is not radiated to a precise position, the laser beam can be focused on the contact site H and can properly connect the pair of unit cells.

As a result, since it is not necessary to pass the laser beam through the electrode tabs 320a and 320b and welding can be conducted by melting only the contact site as an interface, an advantage can be provided in that an amount of input heat can be minimized. When secondary battery unit cells are electrically connected with each other by coupling an electrode tab formed of copper (Cu) and an electrode tab formed of aluminum (Al), an intermetallic compound is inevitably produced. However, in the embodiment of the present invention, since it is possible to minimize an amount of input heat and improve welding efficiency, the production of the intermetallic compound can be suppressed, and accordingly, a welding strength can be increased.

Moreover, as the amount of input heat is minimized, the deformation of subjects, that is, the electrode tabs is prevented, and as an amount of laser output is reduced, costs can be saved and processing reliability can be enhanced.

While it is illustrated in FIG. 10 that all the electrode tabs of the unit cells are flexed by the predetermined angle, it is to be noted that the present invention is not limited to such.

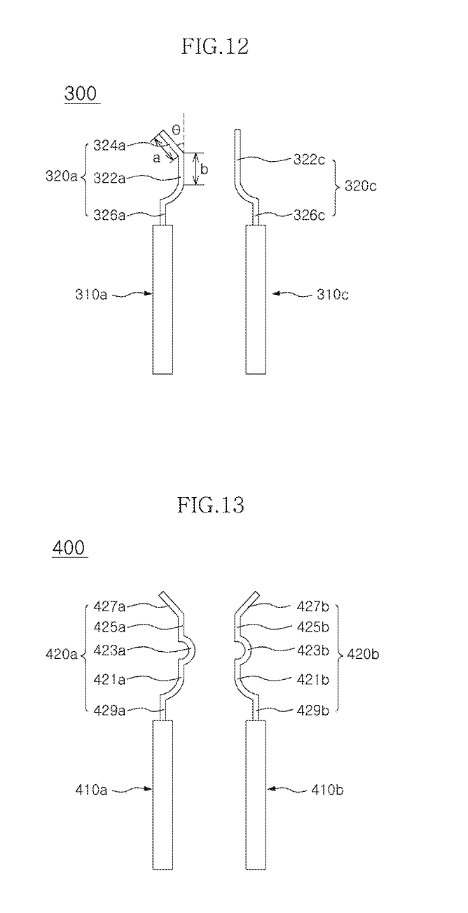

FIG. 12 is a view illustrating the construction of a secondary battery unit cell in accordance with a fourth embodiment of the present invention.

In the present embodiment, when compared to FIG. 10, only any one of adjacent unit cells has a reflective part.

That is to say, as shown in FIG. 12, one electrode tab 320a of a pair of unit cells 300 includes a plate part 322a and a reflective part 324a, and the other electrode tab 320c only includes a plate part 322c. Here, the actual heights of the two electrode tabs 320a and 320c can be the same with each other.

In the present embodiment of the invention, a length a of the reflective part 324a can be set to 0.2 to 5 mm, and a length of a flat portion b included in the plate part 322a can be set to 1 to 10 mm. A bent angle θ of the reflective part 324a can be set to 2° to 45°.

Even in this case, the two unit cells are connected with each other by radiating a laser beam to a contact site after the two electrode tabs 320a and 320c are squeezed toward each other. Multiple reflection of the laser beam occurs by the reflective part 324a provided to the electrode tab 320a, and therefore, even when aiming of the laser beam is not precise, welding of the two unit cells can be properly implemented.

In the present invention, it is not necessary that the bent angles of the reflective parts provided to the unit cells are the same with one another. By constantly maintaining the flexed positions, that is, the heights of the plate parts, the same, corresponding portions can be welded.

FIG. 13 is a view illustrating the construction of a secondary battery unit cell in accordance with a fifth embodiment of the present invention.

Electrode tabs of secondary battery unit cells 400 shown in FIG. 13 include flexed parts. Accordingly, since flexed parts provided to two adjacent electrode tabs are brought into contact with each other, even when a laser beam is radiated with the two electrode tabs not brought into close contact with each other, it is possible to prevent adverse influences from being exerted on cell bodies.

In detail, the secondary battery unit cells 400 in accordance with the present embodiment of the invention include cell bodies 410a and 410b and electrode tabs 420a and 420b.

The electrode tabs 420a and 420b include first plate parts 421a and 421b, flexed parts 423a and 423b, second plate parts 425a and 425b, and reflective parts 427a and 427b. The electrode tabs 420a and 420b can further include lead parts 429a and 429b for securing a minimum connection distance with respect to electrode tabs of adjacent unit cells.

The first plate parts 421a and 421b have a sectional shape of a straight line when viewed from a side and extend in a first direction from the cell bodies 410a and 410b. The flexed parts 423a and 423b extend in the first direction from the first plate parts 421a and 421b in such a way as to have flexed portions when viewed from a side. The second plate parts 425a and 425b have a sectional shape of a straight line when viewed from a side and extend in the first direction from the flexed parts 423a and 423b. The reflective parts 427a and 427b extend from the second plate parts 425a and 425b by being bent by a predetermined angle. The reflective parts 427a and 427b can be bent in opposite directions from a contact site so as to ensure the contact of the electrodes of the adjacent unit cells.

Similarly to the secondary battery unit cell shown in FIG. 5, the secondary battery unit cells 400 in accordance with the present embodiment of the invention have the flexed parts 423a and 423b, and additionally have the reflective parts 427a and 427b on the distal ends thereof.

Accordingly, even when a laser beam is radiated with the two electrode tabs not brought into dose contact with each other, it is possible to prevent the laser beam from being directly radiated to the cell bodies 410a and 410b, due to the presence of the flexed parts 423a and 423b. Further, as multiple reflection of the laser beam occurs by the reflective part 427a and 427b, it is possible to minimize an amount of input heat and improve welding efficiency.

As the amount of input heat is minimized, the deformation of subjects is prevented, and as an amount of laser output is reduced, costs can be saved and processing reliability can be enhanced.

As is apparent from the above description, the secondary battery according to the present invention has electrode tabs each of which includes at least one flexed portion. Accordingly, with adjacent unit cells of the secondary battery electrically contacted, erroneous radiation of a laser beam can be prevented due to the presence of flexed portions.

As a consequence, a secondary battery module can be stably constructed without dangers such as the breakage of the secondary battery or the occurrence of a fire while constructing the secondary battery module.

While certain embodiments have been described above, it will be understood to those skilled in the art that the embodiments described are by way of example only. Accordingly, the secondary battery and the secondary battery module using the same described herein should not be limited based on the described embodiments. Rather, the secondary battery and the secondary battery module using the same described herein should only be limited in light of the claims that follow when taken in conjunction with the above description and accompanying drawings.

What is claimed is:

1. A secondary battery comprising:
a cell body having an electrode assembly disposed therein; and
an electrode tab extending from each electrode of the electrode assembly to an outside of the cell body in a specified direction, and having at least one flexed part at an intermediate portion thereof.

2. The secondary battery according to claim 1, wherein the electrode tab comprises:
a first plate part having a sectional shape of a straight line or a curved line when viewed from a side, and extending in a first direction from the cell body;
at least one flexed part extending in the first direction from the first plate part in such a way as to have a flexed portion when viewed from a side; and
a second plate part having a sectional shape of a straight line or a curved line when viewed from a side and extending in the first direction from the flexed part.

3. The secondary battery according to claim 2, wherein the cell body has flat front and rear surfaces, the first plate part has a flat surface or a flexed surface which extends from the flat front or rear surface of the cell body, the flexed part has a flexed surface which extends from the flat or flexed surface of the first plate part, and the second plate part extends from the flexed surface of the flexed part and has a flat surface which extends in a lengthwise direction of the cell body.

4. The secondary battery according to claim 2, wherein the electrode tab further comprises:
a lead part connected between the cell body and the first plate part.

5. The secondary battery according to claim 1, wherein the electrode tab comprises a positive electrode tab or a negative electrode tab.

6. A secondary battery module using a secondary battery unit cell including a cell body which has an electrode assembly disposed therein and an electrode tab which extends from each electrode of the electrode assembly to an outside of the cell body, wherein the electrode tab extends in a specified direction from the cell body and has at least one flexed part at an intermediate portion thereof, and electrode tabs of at least one pair of adjacent secondary battery unit cells electrically contact each other.

7. The secondary battery module according to claim 6, wherein the electrode tab comprises:
a first plate part having a sectional shape of a straight line or a curved line when viewed from a side, and extending in a first direction from the cell body;
at least one flexed part extending in the first direction from the first plate part in such a way as to have a flexed portion when viewed from a side; and
a second plate part having a sectional shape of a straight line when viewed from a side and extending in a lengthwise direction of the cell body from the flexed part.

8. The secondary battery module according to claim 7, wherein the electrode tab further comprises:
a lead part connected between the cell body and the first plate part.

9. The secondary battery module according to claim 7, wherein the cell body has flat front and rear surfaces, the first plate part has a flat surface or a flexed surface which extends from the flat front or rear surface of the cell body, the flexed part has a flexed surface which extends from the flat or flexed surface of the first plate part, and the second plate part extends from the flexed surface of the flexed part and has a flat surface which extends in the lengthwise direction of the cell body.

10. The secondary battery module according to claim 6, wherein the electrode tabs of the at least one pair of adjacent secondary battery unit cells electrically contact each other by a laser beam which is downwardly radiated in the lengthwise direction of the cell body.

11. The secondary battery module according to claim 10, wherein the electrode tab comprises a positive electrode tab or a negative electrode tab.

12. A secondary battery comprising:
a cell body having an electrode assembly disposed therein; and
an electrode tab extending from each electrode of the electrode assembly to an outside of the cell body in a specified direction, and having at a distal end portion thereof a reflective part which is bent at a predetermined angle.

13. The secondary battery according to claim 12, wherein the electrode tab comprises:
a plate part having a flat portion which extends from the cell body in a lengthwise direction of the cell body; and
the reflective part extending from the flat portion and bent to have the predetermined angle with respect to the flat portion.

14. The secondary battery according to claim 13, wherein the electrode tab further comprises:
a lead part connected between the cell body and the plate part.

15. The secondary battery according to claim 12, wherein the electrode tab comprises:
a first plate part extending from the cell body in the lengthwise direction of the cell body;
at least one flexed part extending in the lengthwise direction of the cell body from the first plate part in such a way as to have a flexed portion when viewed from a side;
a second plate part having a sectional shape of a straight line when viewed from a side and extending from the flexed part in the lengthwise direction of the cell body; and
the reflective part bent from the second plate part to have the predetermined angle with respect to the second plate part.

16. The secondary battery according to claim 12, wherein the secondary battery is constructed to constitute a pair in cooperation with another secondary battery which has an electrode tab with the shape of a straight line and substantially the same height as the electrode tab.

17. A secondary battery module using a secondary battery unit cell including a cell body which has an electrode assembly disposed therein and an electrode tab which extends from each electrode of the electrode assembly to an outside of the cell body, wherein the electrode tab extends in a specified direction from the cell body and has at a distal end portion thereof a reflective part which is bent at a predetermined angle, and electrode tabs of at least one pair of adjacent secondary battery unit cells electrically contact each other.

18. The secondary battery module according to claim 17, wherein the electrode tab comprises:
a plate part having a flat portion which extends from the cell body in a lengthwise direction of the cell body; and
the reflective part extending from the flat portion and bent to have the predetermined angle with respect to the flat portion.

19. The secondary battery module according to claim 18, wherein the electrode tab further comprises:
a lead part connected between the cell body and the plate part.

20. The secondary battery module according to claim 17, wherein the electrode tab comprises:
a first plate part extending from the cell body in the lengthwise direction of the cell body;
at least one flexed part extending in the lengthwise direction of the cell body from the first plate part in such a way as to have a flexed portion when viewed from a side;
a second plate part having a sectional shape of a straight line when viewed from a side and extending from the flexed part in the lengthwise direction of the cell body; and
the reflective part bent from the second plate part to have the predetermined angle with respect to the second plate part.

21. The secondary battery module according to claim 17, wherein the secondary battery is constructed to constitute a pair in cooperation with another secondary battery which has an electrode tab with the shape of a straight line and substantially the same height as the electrode tab.

22. The secondary battery module according to claim 17, wherein the electrode tabs of the at least one pair of adjacent secondary battery unit cells electrically contact each other by a laser beam which is downwardly radiated in the lengthwise direction of the cell body.

23. The secondary battery module according to claim 22, wherein the electrode tab comprises a positive electrode tab or a negative electrode tab.
